(19) United States
(12) Patent Application Publication
(10) Pub. No.: US 2007/0246933 A1
(43) Pub. Date: Oct. 25, 2007

(54) Security Element Comprising a Support

(75) Inventors: Manfred Heim, Munchen (DE); Jurgen Ruck, Schliersee (DE); Theodor Burchard, Gmund (DE)

Correspondence Address: GREENLEE WINNER AND SULLIVAN P C, 4875 PEARL EAST CIRCLE, SUITE 200, BOULDER, CO, 80301, US

(73) Assignee: Giesecke & Devrient GMBH, Munchen (DE)

(21) Appl. No.: 11/573,484

(22) PCT Filed: Aug. 8, 2005
(86) PCT No.: PCT/EP05/08567

§ 371 Date: Feb. 9, 2007

(30) Foreign Application Priority Data
Aug. 12, 2004 (DE) 10 2004 039 355.9
Oct. 25, 2004 (DE) 10 2004 051 919.6

(51) Int. Cl. B42D 15/00

(52) U.S. Cl. 283/98; 283/106; 283/109

(57) ABSTRACT

The present invention relates to a security element (20) for securing security papers, value documents and the like, having a substrate (22). According to the present invention, the substrate (22) is provided with an authenticating mark (24, 26) that, in transmitted light, imparts a first optical impression and, in reflected light, against a predefined and easily accessible background, imparts a second optical impression that differs significantly from the first optical impression.

The present invention relates to a security element for securing security papers, value documents and the like, having a transparent or translucent substrate. The present invention further relates to a security arrangement having such a security element and a security document furnished accordingly.

See-through windows in banknotes have been known for some time in the field of polymer notes. However, on its own, providing a banknote with a see-through window does not yet offer any additional counterfeit security for the note. Thus, different security features for see-through windows have been suggested and, to some extent, also implemented in banknotes.

For example, the publication WO 98/15418 A1 describes a self-verifying banknote composed of a flexible sheet of a plastic substrate having an identification mark. The self-verifying banknote exhibits a transparent window area that includes a self-verification means for verifying a security element disposed in a laterally distanced area of the sheet. The self-verification occurs in that the window area is brought into register with the security element by bending or folding the sheet, and the security element and the self-verification means coact there in a suitable manner to authenticate the banknote.

Frequently and to a currently still increasing extent, the security features for see-through windows are designed such that more or less complex auxiliary means are required for checking the authenticity of the security feature disposed in the window. Typically, external UV lamps, polarization filters, moiré filters or even laser sources that shine through the see-through window are needed for the authenticity check, to verify the security feature.

However, complex auxiliary means are not always available and the authenticity check carried out therewith is often relatively time consuming. Here, users feel that even a check that lasts several seconds is time consuming and bothersome. In many cases, the authenticity check is then omitted entirely, such that the protective effect of the security feature comes to nothing.

Based on that, the object of the present invention is to specify a generic security element that avoids the disadvantages of the background art. In particular, the security element should be difficult to imitate and able to be checked for authenticity with simple auxiliary means that are available nearly everywhere.

This object is solved by the security element having the features of the main claim. A security arrangement having such a security element, as well as a corresponding security document, are specified in the coordinated claims. Developments of the present invention are the subject of the dependent claims.

According to the present invention, the transparent or translucent substrate of the security element is provided with an authenticating mark that, in transmitted light, imparts a first optical impression and, in reflected light, imparts, against a predefined and easily accessible background, a second optical impression that differs significantly from the first optical impression. This facilitates a simple and quick authenticity check in which the security element is first viewed in transmitted light and is then held against a predefined background. If the second optical impression stands out significantly from the first optical impression, or even if new patterns or optical effects appear, the banknote can be judged by users as authentic.

Advantageously, in transmitted light, the authenticating mark appears patternless, transparent or translucent, and colorless. Compared with such an inconspicuous appearance, a different optical impression can be perceived particularly easily.

In reflected light, against the predefined background, the authenticating mark then preferably appears having a defined color impression. The authenticating mark can appear contiguously having a uniform color or having different colors that can also form a pattern. The defined color impression is preferably present in the form of patterns, characters or codes, such as in the form of the denomination of a banknote.

In other embodiments, the authenticating mark is not completely colorless in transmitted light, but rather appears patternless, transparent or translucent, and having a first defined color impression. In reflected light, against the predefined background, the authenticating mark then advantageously appears having a second defined color impression, the tone and/or color intensity of the second color impression differing significantly from the first color impression. The second defined color impression is preferably present in the form of patterns, characters or codes.

While the variants described thus far impart an inconspicuous, patternless impression in transmitted light, according to a further design variant, it is provided that the authenticating mark displays patterns, characters or codes in transmitted light. Preferably, the appearance or the piece of information constituted by the patterns, characters or codes changes significantly in reflected light against the predefined background, or they disappear completely.

Additionally, in all designs, a printing layer can be provided that, in reflected light or transmitted light, yields, together with patterns, characters or codes of the authenticating mark, an aggregate piece of information. When switched from transmitted light view to reflected light view or from reflected light view to transmitted light view, the aggregate piece of information can appear or disappear, or it is changed, especially complemented.

Alternatively or in addition to a change in tone and/or color intensity, in reflected light, against the predefined background, the authenticating mark can display an optically variable effect. This can be, for example, a viewing-angle-dependent color-shift effect that gives the viewer a color impression that changes with the viewing direction. Diffraction effects, scattering effects, especially stemming from a matte finish, and refractive effects, especially caused by microlenses and/or micromirrors, may also be used.

The predefined and easily accessible background can especially be a highly reflective, especially a metallic, surface, a colored or uncolored plastic or glass panel, a highly absorptive, dark surface, or a self-illuminating source of polarized light, especially an LCD display device. All of these background types can be found abundantly in common surroundings and are thus available practically everywhere without further effort to authenticate the security element.

In a preferred embodiment of the security element according to the present invention, the authenticating mark includes a linearly polarizing layer and a phase-shifting layer. The phase-shifting layer can especially be formed by a birefringent or an optically active layer.

The linearly polarizing layer is preferably effective in the entire visible spectral range, but it can also have polarizing properties only in a sub-range of the visible spectrum. The linearly polarizing layer can be formed by a layer applied to the transparent or translucent substrate, a foil joined with the transparent or translucent substrate, or also by the transparent or translucent substrate itself.

To achieve a sufficient difference in the optical impression, it has proven to be advantageous when the phase-shifting layer produces, at least in one wavelength range in the visible spectral range, an optical phase shift of a tenth of a visible wavelength or more.

In a variant of the present invention, the phase-shifting layer is formed by the transparent or translucent substrate itself, and a separate phase-shifting layer can then be omitted. However, high flexibility of the design is achieved when the phase-shifting layer is formed by a separate layer applied on the transparent or translucent substrate. Especially oriented liquid crystal layers lend themselves as materials for the phase-shifting layer. The phase-shifting layer and/or the linearly polarizing layer are expediently present in the form of patterns, characters or codes.

In another, likewise preferred embodiment, the authenticating mark includes one or more layers composed of liquid crystal material, especially composed of cholesteric liquid crystal material. In transmitted light, the liquid crystal layers are transparent and substantially colorless, but against a highly absorptive dark background, appear having intense colors. In this way, when the security element is tilted sideways out of the vertical, they produce a color-shift effect that, depending on the design, can change from a longwave to a shorter-wave color impression, or conversely, from a shortwave to a longer-wave color impression. The liquid crystal layers, too, are advantageously present in the form of patterns, characters or codes.

According to a further advantageous embodiment, the authenticating mark includes a transparent thin-film element having an absorber layer and a dielectric spacing layer disposed between the absorber layer and the transparent or translucent substrate. Here, the absorber layer and/or the dielectric spacing layer can be present in the form of patterns, characters or codes.

In all described embodiments, the authenticating mark of the security element according to the present invention can include a transparent areal diffraction pattern. Here, the diffraction pattern advantageously exhibits, disposed on the substrate, an embossing pattern that, in a variant of the present invention, is provided with a high-index coating. Instead of the high-index coating, also a transparent thin-film element of the kind described above can be applied to the embossing pattern. Then, in addition to the diffraction image of the diffraction pattern, the color impression and the color-shift effect of the thin-film element also appear when viewed in reflected light against the predefined background.

The present invention also includes a security arrangement for securing security papers, value documents and the like that, in addition to a security element of the kind described above, exhibits a verification element that provides the predefined background for viewing the security element in reflected light. Here, in one variant of the present invention, the verification element exhibits a highly reflective, especially metallic surface area that can be formed especially by a further metallized security element, such as a security strip or a patch. In another variant of the present invention, the verification element exhibits a highly absorptive, dark surface area. This absorptive surface area, too, can be provided with further security features, for example a magnetic code.

If a security document is furnished with such a security arrangement, the authenticity check can also always occur with the verification element of the security arrangement. Here, in a special embodiment, it is provided that a damageless check of the authenticating mark of a security arrangement is practicable exclusively with a verification element of a security arrangement disposed on another security document. To carry out the authenticity check, users are then forced to make use of a second, identical security document.

The present invention further comprises a security document, such as a security paper, value document or the like, having a security element or a security arrangement of the kind described. In the latter case, the authenticating mark and the verification element are so geometrically disposed on the security document that the authenticating mark is bringable over the verification element by bending or folding the security document.

The security document advantageously exhibits a paper or plastic substrate. The authenticating feature is preferably disposed in or over a window area or a through opening of the security document. If the security document exhibits a plastic substrate, then the authenticating mark is advantageously applied over a transparent or translucent, especially unprinted, area of the transparent or translucent plastic substrate.

In the case of a paper substrate, the authenticating mark is preferably applied over a through opening of the paper substrate or introduced into such an opening with papermaking technology. Here, the through opening can be produced during paper manufacture without a sharp boundary edge of its border area, such that a characteristic deckle edge is created that cannot be copied by cutting or diecutting.

The security document especially constitutes a security paper or a value document, such as a banknote, a check, an identification card, a certificate or the like.

Further exemplary embodiments and advantages of the present invention are explained below by reference to the drawings, in which a depiction to scale and proportion was omitted in order to improve their clarity.

Shown are:

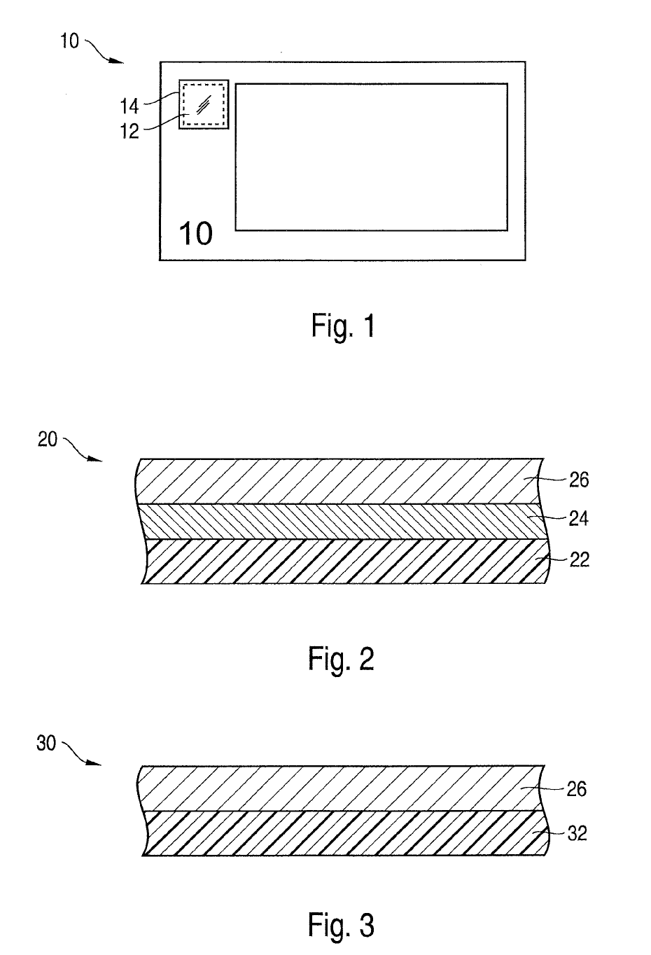

FIG. 1 a schematic diagram of a banknote having a see-through area, over which a security element according to the present invention is disposed,

FIG. 2 the layer structure of a security element according to an exemplary embodiment of the present invention, in cross section,

FIG. 3 to 7 cross-sectional views of security elements according to further exemplary embodiments of the present invention,

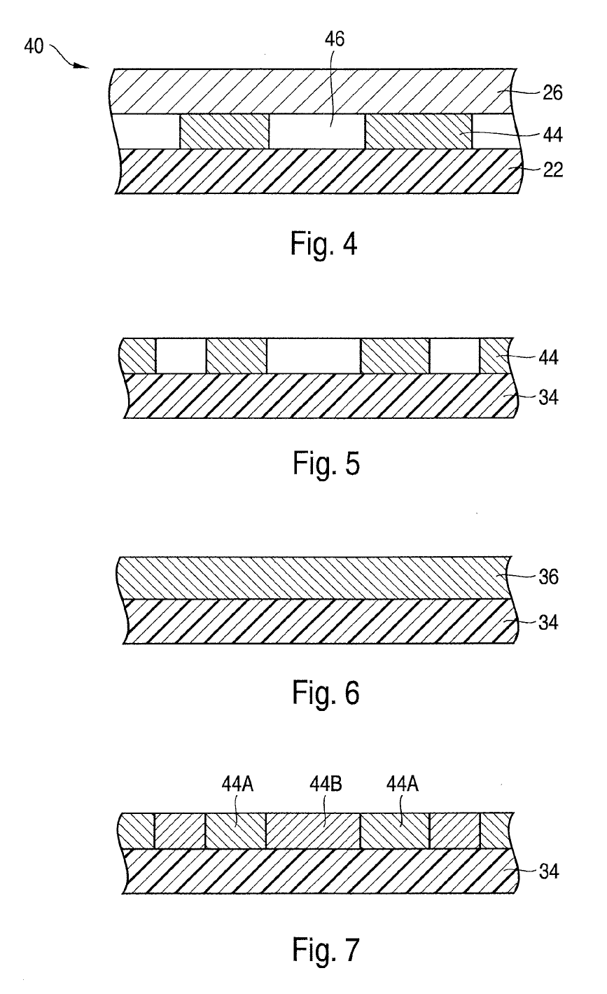

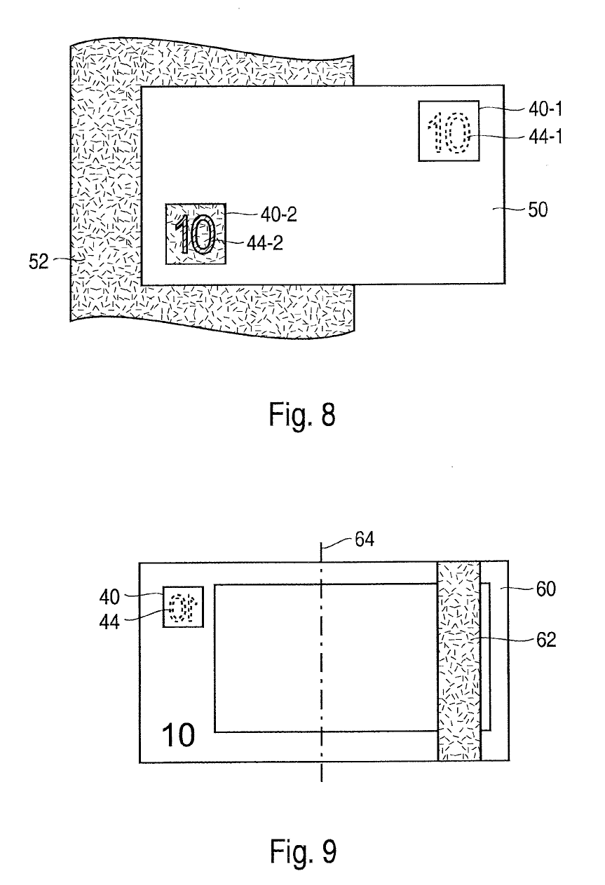

FIG. 8 the authenticity check, against a metallic background, of a banknote provided with two security elements according to FIG. 4,

FIG. 9 a banknote having an inventive security arrangement having a security element according to FIG. 4 and a verification element formed by a security strip,

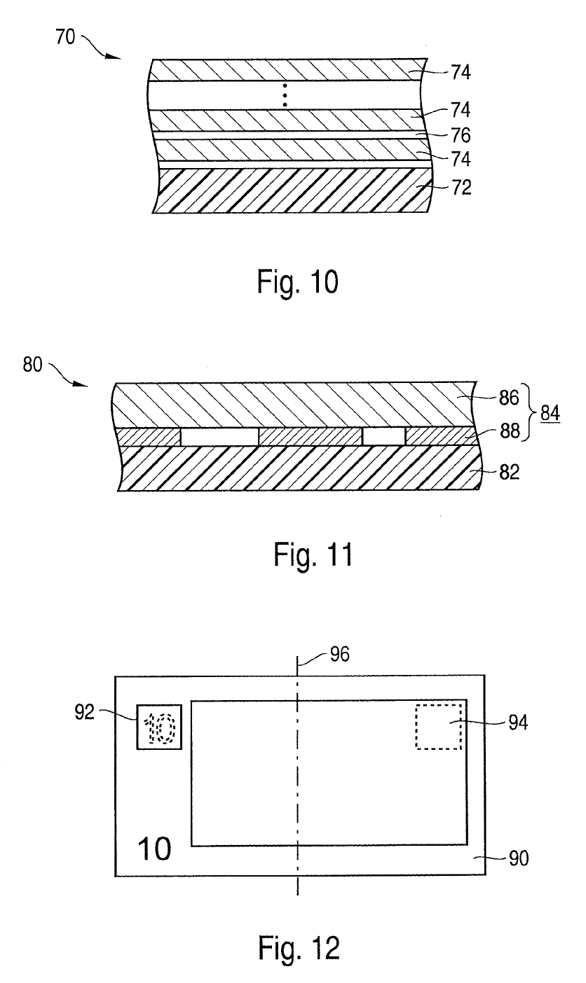

FIGS. 10 and 11 cross-sectional views of security elements according to further exemplary embodiments of the present invention,

FIG. 12 a banknote having an inventive security arrangement having a security element according to FIG. 10 or 11 and a verification element formed by a dark surface area,

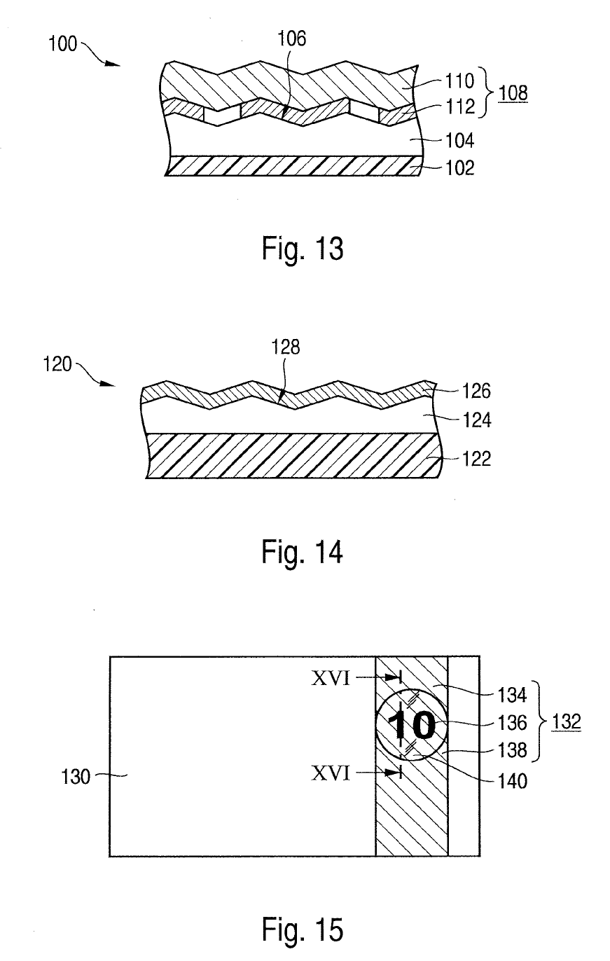

FIGS. 13 and 14 cross-sectional views of security elements according to further exemplary embodiments of the present invention,

FIG. 15 a banknote having a security element according to yet a further exemplary embodiment, as viewed from above,

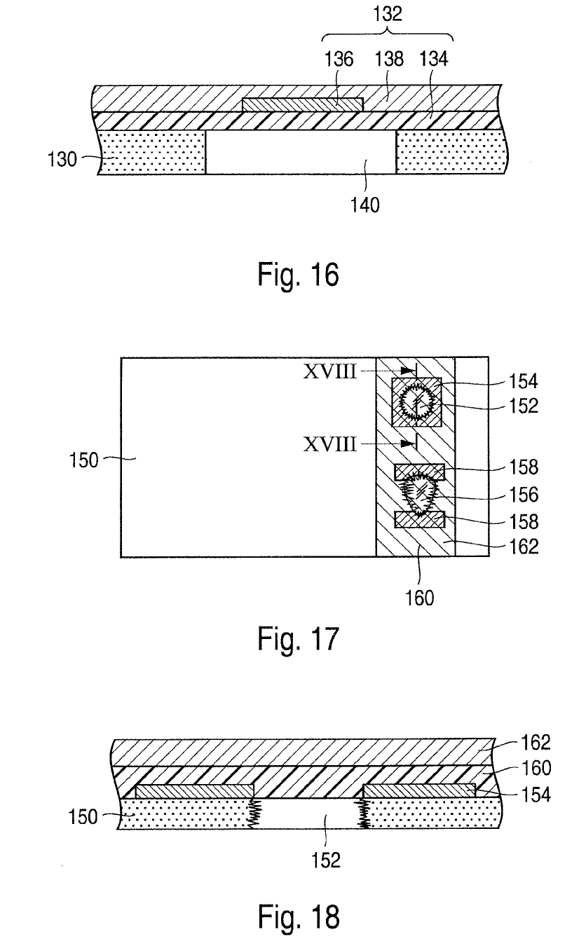

FIG. 16 a cross section through the banknote and the security element in FIG. 15 along the line XVI-XVI,

FIG. 17 a banknote having a security element according to a further exemplary embodiment, as viewed from above,

FIG. 18 a cross section through the banknote and the security element in FIG. 17 along the line XVIII-XVIII, and

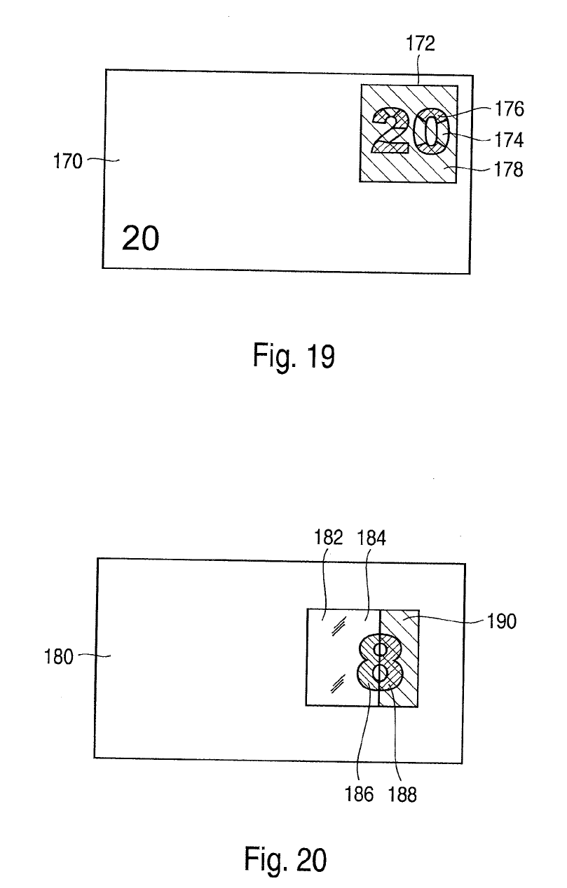

FIGS. 19 and 20 two banknotes having inventive security elements according to further exemplary embodiments of the present invention, as viewed from above.

The invention will be explained below using a banknote as an example. FIG. 1 shows a schematic diagram of a banknote 10 having a see-through area 12 in a lateral sub-area of the note. The see-through area 12 can be, for example, a through opening or a transparent sub-area of the banknote 10. In or over this see-through area 12 is disposed a transparent security element 14 according to the present invention.

When the banknote 10 is viewed in transmitted light, the security element 14 imparts a first optical impression, in the exemplary embodiment the impression of a patternless and substantially colorless transparent surface. In other embodiments, the security element can also be designed such that, in transmitted light, it already exhibits, contiguously, a slight coloration having a defined color impression.

If the banknote 10 having the security element 14 is held against a background of the predefined kind, then the security element 14 imparts a second optical impression that differs significantly from the first optical impression. This clear change in the appearance can be used to check the authenticity of the banknote. As explained in greater detail below, in the transition from transmitted light view to reflected light view, the color impression, for example, that is, the tone or color intensity of the security element 14, changes drastically, patterns, characters or codes appear or disappear, or an optically variable effect is displayed, such as a color-shift effect or a viewing-angle-dependent diffraction image, that is not perceptible in transmitted light.

FIG. 2 shows the layer structure of a security element 20 according to a first exemplary embodiment of the present invention. The security element 20 in FIG. 2 exhibits a substrate layer 22 composed of a transparent foil to which are applied a phase-shifting layer 24 and a linearly polarizing layer 26. Here, the main axis of the phase-shifting layer 24 is rotated by at least 10°, in the exemplary embodiment by 45°, against the polarization direction of the linearly polarizing layer 26. The phase-shifting layer 24 can be formed, for example, from a birefringent or an optically active material, such as a liquid crystal material, for example in the nematic or smectic phase.

In transmitted light, the security element 20 appears transparent and patternless. If, on the other hand, it is viewed against a highly reflective background, such as a metal surface or the like, it displays very marked colors whose intensity and tone can be varied in a broad range through the optical properties of the phase-shifting layer 24 and the linearly polarizing layer 26.

In the exemplary embodiment, the layer 26 has linearly polarizing properties over the entire visible wavelength range. As the phase-shifting layer 24, a birefringent layer is used whose layer thickness and difference in the refractive indices of the ordinary and extraordinary ray nₒ-nₑ is chosen in the exemplary embodiment such that it constitutes a λ/4-layer for red light having λ=640 nm. Red light is then linearly polarized by the layer 26 and, when it passes through the layer 24 twice and, in between, reflects on the metallic background, the linearly polarized light undergoes a total phase rotation of 90° such that the returning light is blocked by the linearly polarizing layer 26. If white light is incident on the security element, then, after passing through the security element twice, the returning light lacks a large portion of the red light, such that the security element appears in a characteristic blue tone. Analogously, different color effects can be produced by choosing the birefringent properties of the layer 24 or by choosing its layer thickness.

In the security element 30 of the exemplary embodiment shown in FIG. 3, the linearly polarizing layer 26 is applied on a transparent substrate foil 32 having birefringent properties such that a separate phase-shifting layer can be omitted.

FIG. 4 shows a security element 40 according to a further exemplary embodiment of the present invention that, in principle, is structured like the exemplary embodiment in FIG. 2. In contrast to the exemplary embodiment shown there, the phase-shifting layer 44 in FIG. 4 is present only in some areas in the form of a code, for example in the form of lettering, or of a symbol. In transmitted light, the entire surface of the security element appears colorless and patternless. Against a highly reflective background, the optical impression does not change in the gap areas 46, while the areas in which the phase-shifting layer 44 is applied light up in color and make the code visible.

FIG. 5 shows a further variant of the security element in FIG. 2 in which a phase-shifting layer 44 composed of liquid crystal material is applied to a substrate foil 34 having linearly polarizing properties. As in the exemplary embodiment in FIG. 4, the phase-shifting layer 44 is applied only in some areas in the form of a code. In this variant, the separate linearly polarizing layer is dispensable, since this function is already assumed by the substrate foil 34. Suitable linearly polarizing foils are commercially available. Manufacturing methods for wavelength-selectively polarizing foils are described, for example, in publication WO 2004/009373, whose disclosure in this respect is incorporated in the present application.

A further modification is depicted in FIG. 6. The security element shown there includes two foils joined together. The linearly polarizing substrate foil 34 is joined with a second phase-shifting foil 36 of suitable layer thickness. The second foil 36 can consist, for example, of PET or of polypropylene. To achieve the desired effect, care must merely be taken that the main axis of the birefringent foil 36 and the axis of the linearly polarizing foil 34 are tilted toward each other.

FIG. 7 shows a further variant of a security element according to the present invention. Here, multiple phase-shifting layers 44A and 44B having different optical properties are applied on a linearly polarizing substrate foil 34. The layers 44A, 44B can be formed, for example, by liquid crystal layers having differing orientation directions. In this way, multicolored codes can be realized at verification. It is understood that also more than two different phase-shifting layers can be used, and that also the other designs described can be provided in an analogous manner with multicolored verification features.

The authenticity check of a banknote provided with security elements 40 is illustrated in FIG. 8. The banknote 50 exhibits, applied in see-through areas of the banknote, two identical security elements 40-1, 40-2 in which the phase-shifting layer 44-1 or 44-2 is present in each case in the form of the denomination of the banknote as the numeric string “10”. In transmitted light, the security elements appear patternless and inconspicuous, the encoded numeric string is not perceptible. This is denoted in the right security element 40-1 in the figure by the dotted depiction of the numeric string 44-1. If the banknote 50 or, as in FIG. 8, a portion of the note is viewed against a metallic background 52, then the areas of the security element 40-2 provided with the phase-shifting layer 44-2 appear as clearly visible colored lettering “10” due to the effects described above.

The verification can also occur with a good non-metallic reflector. Smooth, colored plastic panels or smooth, colored glass panels are particularly well suited, but simple, uncolored glass or plastic panels can also be used. The conspicuousness of the features can be further increased if a dark background is disposed behind the transparent glass or plastic panels.

A further possibility consists in the verification of the security elements with the aid of LCD display devices, such as are prevalent as computer monitors, high-quality televisions and displays in a number of portable devices in the consumer electronics segment. Such LCD display devices emit linearly polarized light such that the security elements can also be verified in that they are held on or against an LCD display device or are laid on the display.

As the verification element, the above-described security elements use in each case a separate, for example metallic, background, such as can be found everywhere in the environment. The check of the security element can thus be carried out by anyone, quickly and without any special effort. However, a metallic verification element can also be disposed on the banknote itself, as illustrated in the exemplary embodiment in FIG. 9.

The banknote 60 in FIG. 9 includes a security element 40 of the kind described with reference to FIG. 4, as well as a metallized security strip 62. The security strip 62 is typically furnished with further security features that are not depicted in the drawing, such as inverse lettering, optically variable diffraction patterns, a magnetic code or the like. The security element 40 and the security strip 62 are disposed mirror-symmetrically to the centerline 64 of the banknote 60 such that the security element 40 comes to rest on the security strip by folding the banknote about this centerline. The banknote 60 can thus be checked for authenticity by simple folding, without external verification means being required. It is understood that the check of the banknote 60 can also occur with a security strip applied on another banknote.

The differentness of the two optical impressions of the security element in transmitted light view and reflected light view can also be ensured in another way. For this, FIG. 10 shows the principle layer structure of a security element 70 that exhibits one or more layers composed of liquid crystal material. The security element 70 includes a transparent substrate 72, for example a smooth PET foil of good surface quality on which are applied one or more layers 74 composed of a cholesteric liquid crystal material. Between the liquid crystal layers 74, alignment layers and/or adhesive layers 76 can be provided that serve to align the liquid crystals in the liquid crystal layers, or to join the individual liquid crystal layers and compensate for surface irregularities.

Viewed in transmitted light, the security element 70 appears colorless and patternless. If, in contrast, it is viewed against a highly absorptive, dark background, then the liquid crystal layers produce an intensely colored impression. In addition, when viewed against a dark background and the viewing angle is changed, a color-shift effect becomes visible that typically changes from a longwave to a shorter-wave color impression, for example from green to blue, but that, when multiple liquid crystal layers are combined, can also change from a shortwave to a longer-wave color impression, such as from blue or violet to red.

The liquid crystal layers 74 can also be present only in some areas in the form of lettering or of a symbol, or they can exhibit appropriate information-bearing gaps. The encoded piece of information then appears, analogously to the above-described situation, only when the security element 70 is viewed against the predefined absorptive background.

FIG. 11 shows a security element 80 according to a further exemplary embodiment of the present invention. The security element 80 exhibits a transparent substrate 82 that is provided with an authenticating mark in the form of a transparent thin-film element 84. Here, the thin-film element 84 consists of an ultrathin dielectric spacing layer 86, for example a 200 nm to 500 nm thick SiO₂ layer, and of an absorber layer 88 that can consist of a 4 nm to 20 nm thick metal layer composed of chrome, iron, gold, aluminum or titanium.

Viewed in transmitted light, the security element 80 appears transparent and colorless. Against a highly absorptive background, in contrast, a strong color effect occurs due to interference effects in the sub-layers of the thin-film element 84. In addition, a clearly perceptible color-shift effect results when the security element 80 is tilted.

The dielectric spacing layer 86 or, preferably, the absorber layer 88 can, as shown in FIG. 11, also be present only in some areas and form lettering or another code. The strong color effect and the color-shift effect then occur only in the areas in which the absorber layer 88 is present.

The designs described with reference to FIGS. 10 and 11 each require as the verification element a highly absorptive, dark background that is easily available in common surroundings. However, in this variant, too, a verification element can be disposed on the banknote itself, as shown with reference to FIG. 12.

For this, the banknote 90 exhibits, disposed in a see-through area, a security element 92 that can be formed, for example, like the liquid crystal layer security element 70 in FIG. 10 or the thin-layer security element 80 in FIG. 11. On the reverse of the banknote 90 is disposed a dark, absorptive surface area 94. The surface area 94 need not be patternless, it can include, for example, a portrait that is kept dark or another graphic motif in dark tones. Like the security strip 62 in FIG. 9, the surface area 94 can also be furnished with further security features.

In transmitted light, the see-through area of the banknote 90 displays a colorless and patternless appearance. If the banknote 90 is folded along its centerline 96 and the dark surface area 94 is thus folded under the security element 92, the color effect of the security element stands out clearly. In the exemplary embodiment, the numeric string “10” appears in clear, bright colors. In addition, when the folded banknote 90 is tilted sideways, a color-shift effect occurs whose expression depends on the precise design of the security element 92.

In the security element 100 of the exemplary embodiment shown in FIG. 13, besides a thin-film element having a color-shift effect, an areal diffraction pattern, such as a hologram or a hologram-like diffraction pattern, is additionally provided. For this, on a transparent substrate foil 102, a likewise transparent embossing lacquer layer 104 is applied and a desired diffraction pattern 106 is embossed.

To the embossing lacquer layer 104 is further applied a thin-film element 108 whose layer structure, as in FIG. 11, comprises an ultrathin dielectric spacing layer 110 and an absorber layer 112. Here, the relief of the diffraction pattern 106 continues vertically upwardly in the thin-film element 108. In this exemplary embodiment, too, the absorber layer 112 is present only in some areas to provide the security element 100 with lettering or another code.

In transmitted light, the security element 100 is perceived as a transparent, patternless surface, neither the color-shift effect of the thin-film element 108 nor the diffraction image of the diffraction pattern 106 appears noticeably. If, in contrast, the security element 100 is viewed in reflected light against a dark, highly absorptive background, then besides the color effect already described and the color-shift effect of the thin-film element 108, also the diffraction patterns 106 stand out clearly and facilitate the authenticity check of the document provided with the security element 100. Since the security element 100 must be transparent in transmitted light, it cannot be copied with the aid of commercially available color-shifting foils or through printing layers having color-shifting pigments.

Instead of the diffraction pattern, the security element can also be provided with a matte pattern or a refractive pattern composed of micromirrors or microlenses.

FIG. 14 shows a further exemplary embodiment of the present invention. In this case, the security element 120 exhibits a transparent substrate foil 122 having a transparent embossing lacquer layer 124 and a high-index coating 126. In the embossing lacquer layer 124 is embossed a desired diffraction pattern 128, for example a hologram or a hologram-like relief pattern. When looked through, the security element 120 appears substantially as a colorless and patternless see-through window. In reflected light against a dark background, the diffraction pattern 128 stands out clearly and thus facilitates the authentication of the document provided with the security element 120.

In transmitted light, the security elements described so far usually display a rather inconspicuous optical impression and, when viewed against a predefined background, allow new features to be perceived. According to the present invention, also features that are visible in transmitted light can disappear when laid on a suitable background, or a piece of information that is visible in transmitted light can be complemented or changed in another way when viewed against a suitable background. Exemplary embodiments are explained below with reference to FIGS. 15 to 20.

FIGS. 15 and 16 show a banknote 130 having a security element 132 according to the present invention, FIG. 15 showing the banknote as viewed from above and FIG. 16 showing a section through the banknote and the security element along the line XVI-XVI. The security element 132 includes a transparent foil strip 134 that is provided with a black imprint 136, here in the form of the numeric string “10”, and a liquid crystal layer 138 applied thereover. The black imprint 136 can, as in FIG. 16, be disposed on the topside of the foil, or also on its underside. A see-through area of the banknote, here a through opening 140, is completely covered by the foil strip 134.

When the banknote is viewed against a light background, the black imprint 136 is clearly visible within the see-through area 140, but it disappears for the viewer when the banknote is laid on a dark, especially black, background due to the contrast that is then lacking. Rather, after laying it down, the entire opening 140 appears contiguously having a uniform characteristic shimmer that stems from the liquid crystal layer 138.

A further variant is shown in FIGS. 17 and 18, FIG. 17 showing a top view of a banknote 150 having a security element according to the present invention and FIG. 18 showing a section through the banknote and the security element along the line XVIII-XVIII. The banknote 150 was provided during paper manufacture with through openings 152 and 156 having a characteristic deckle edge that cannot be copied by cutting or diecutting.

Further, in an area surrounding the first opening 152, the banknote is provided with a black imprint 154, while the second opening 156 joins two spaced apart areas 158 that are formed by black imprints. The openings 152 and 156 and the associated imprints 154 and 158 are covered by a transparent foil strip 160 provided with a liquid crystal layer 162. It is understood that the black imprints 154 and 158 can also be applied on the top or underside of the foil 160 instead of on the banknote paper.

Alternatively to the black imprints, it is also possible to apply a patch in position, e.g. by means of hot embossing methods. Of course this also applies to all other embodiments.

Against a light background, the openings 152 and 156 stand out clearly from the black imprints 154 and 158. The viewing impression changes when viewed against a dark, especially black, background: The opening 152 and the imprint 154 then appear as a contiguous square, the opening 156 forms, together with the imprints 158, a continuous dark surface. Furthermore, all dark surface areas display in each case the characteristic shimmer of the liquid crystal layer 162.

The embodiments explained in FIGS. 15 to 18 can be used to have a piece of information encoded in a security element appear or disappear when the background changes, or to alter or complement it.

By way of example, FIG. 19 shows a banknote 170 having a security element 172 of the kind explained with reference to FIG. 17. The banknote 170 exhibits four through openings 174 and five black print areas 176 that complement one another to depict the desired piece of information, in the exemplary embodiment the numeric string “20”. Here, the area of the openings 174 and the black print areas 176 is covered with a transparent, liquid crystal coated foil 178.

When viewed against a light background, the openings 174 appear light, the black print areas 176, in contrast, dark, such that the numeric string is not perceptible as such. In contrast, when viewed against a dark background, the areas 174 and 176 appear equally dark, such that the numeric string “20” then stands out clearly as a whole.

Another effect is exploited in the exemplary embodiment in FIG. 20. The banknote 180 depicted there exhibits a see-through area 182 that is covered with a transparent foil 184. The foil 184 is provided in a sub-area with a liquid crystal layer 186 in the form of the left half of the numeral “8”. Adjoining the see-through area 182, a black imprint 188 is applied to the banknote paper in the form of the right half of the numeral “8”. The area of the banknote containing the imprint 188 is additionally overprinted with a liquid crystal layer 190.

On the banknote, against a light background, only the black imprint 188 is perceptible, which constitutes only a portion of the aggregate piece of information. The liquid crystal area 186, in contrast, is hardly visible or not at all. Only when laid on a black background does the entire numeral “8” appear, through the characteristic shimmering of the liquid crystals.

The liquid crystal material in the exemplary embodiments 15 to 20 can be present, for example, in the form of pigments embedded in a binder matrix. The liquid crystal layers can also be entirely or partially patterned and formed, for example, in the form of a crosshatching.

1. A security element for securing security papers, value documents and the like, having a transparent or translucent substrate, characterized in that the transparent or translucent substrate is provided with an authenticating mark that, in transmitted light, imparts a first optical impression and, in reflected light, imparts, against a predefined and easily accessible background, a second optical impression that differs significantly from the first optical impression.

2. The security element according to claim 1, characterized in that, in transmitted light, the authenticating mark appears patternless, transparent or translucent, and colorless.

3. The security element according to claim 1, characterized in that, in reflected light, the authenticating mark appears having a defined color impression against the predefined background.

4. The security element according to claim 3, characterized in that the defined color impression is present in the form of patterns, characters or codes.

5. The security element according to claim 1, characterized in that, in transmitted light, the authenticating mark appears patternless, transparent or translucent having a first defined color impression.

6. The security element according to claim 5, characterized in that, in reflected light, the authenticating mark appears against the predefined background and having a second defined color impression, the tone and/or color intensity of the second color impression differing significantly from the first color impression.

7. The security element according to claim 6, characterized in that the second defined color impression is present in the form of patterns, characters or codes.

8. The security element according to claim 1, characterized in that, in transmitted light, the authenticating mark displays patterns, characters or codes.

9. The security element according to claim 8, characterized in that, in reflected light, the appearance or the information content of the patterns, characters or codes of the authenticating mark changes significantly against the predefined background, or that the patterns, characters or codes disappear completely.

10. The security element according to claim 1, characterized in that a printing layer is provided that, in reflected light or transmitted light, yields, together with patterns, characters or codes of the authenticating mark, an entire piece of information.

11. The security element according to claim 10, characterized in that, when switched from transmitted light view to reflected light view or from reflected light view to transmitted light view, the entire piece of information appears, disappears or is changed, especially is complemented.

12. The security element according to claim 1, characterized in that, in reflected light, the authenticating mark displays an optically variable effect against the predefined background.

13. The security element according to claim 12, characterized in that one or more effects from the group: diffraction effects, viewing-angle-dependent color-shift effects, scattering effects, especially stemming from a matte finish, and refractive effects, especially caused by microlenses and/or micromirrors, is used as the optically variable effect.

14. The security element according to claim 1, characterized in that the predefined background is a highly reflective, especially a metallic, surface, or a colored or uncolored plastic or glass panel.

15. The security element according to claim 1, characterized in that the predefined background is a self-illuminating source of polarized light, especially an LCD display device.

16. The security element according to claim 1, characterized in that the predefined background is a highly absorptive, dark surface.

17. The security element according to claim 1, characterized in that the authenticating mark includes a linearly polarizing layer and a phase-shifting, especially birefringent, layer.

18. The security element according to claim 17, characterized in that the linearly polarizing layer is effective in the entire visible spectral range.

19. The security element according to claim 17, characterized in that the linearly polarizing layer is effective only in a sub-range of the visible spectrum.

20. The security element according to claim 17, characterized in that the linearly polarizing layer is formed by the transparent or translucent substrate itself.

21. The security element according to claim 17, characterized in that, at least in one wavelength range in the visible spectral range, the phase-shifting layer produces an optical phase shift of a tenth of a visible wavelength or more.

22. The security element according to claim 17, characterized in that the phase-shifting layer is formed by the transparent or translucent substrate itself.

23. The security element according to claim 17, characterized in that the phase-shifting layer is formed by a layer applied on the transparent or translucent substrate, especially an applied liquid crystal layer.

24. The security element according to claim 17, characterized in that the phase-shifting layer and/or the linearly polarizing layer are present in the form of patterns, characters or codes.

25. The security element according to claim 1, characterized in that the authenticating mark includes one or more layers composed of liquid crystal material, especially composed of cholesteric liquid crystal material.

26. The security element according to claim 25, characterized in that the one or more liquid crystal layers are present in the form of patterns, characters or codes.

27. The security element according to claim 1, characterized in that the authenticating mark includes a transparent or translucent thin-film element having a dielectric spacing layer and an absorber layer disposed between the spacing layer and the transparent or translucent substrate.

28. The security element according to claim 27, characterized in that the absorber layer and/or the dielectric spacing layer are present in the form of patterns, characters or codes.

29. The security element according to claim 1, characterized in that the authenticating mark includes an areal diffraction pattern.

30. The security element according to claim 29, characterized in that the areal diffraction pattern exhibits an embossing pattern disposed on the substrate.

31. The security element according to claim 30, characterized in that the embossing pattern is provided with a high-index coating.

32. The security element according to claim 27, characterized in that the authenticating mark includes an areal diffraction pattern, and characterized in that the areal diffraction pattern exhibits an embossing pattern disposed on the substrate, further characterized in that the transparent or translucent thin-film element is applied to the embossing pattern.

33. The security element according to claim 1, characterized in that the authenticating mark includes a matte finish, an arrangement composed of microlenses or an arrangement composed of micromirrors.

34. A security arrangement for securing security papers, value documents and the like, having a security element according to claim 1 and a verification element that provides the predefined background for viewing the security element in reflected light.

35. The security arrangement according to claim 34, characterized in that the verification element exhibits a highly reflective, especially metallic, surface area.

36. The security arrangement according to claim 35, characterized in that the verification element constitutes a further metallized security element, such as a security strip or a patch.

37. The security arrangement according to claim 34, characterized in that the verification element exhibits a highly absorptive, dark surface area.

38. The security arrangement according to claim 34, characterized in that a damageless check of the authenticating mark of a security arrangement is practicable solely with a verification element of a security arrangement disposed on another security document.

39. A security document, such as a security paper, value document or the like, having a security element according to claim 1.

40. A security document, such as a security paper, value document or the like, having a security arrangement according to claim 34.

41. The security document according to claim 40, characterized in that the authenticating mark and the verification element are so geometrically disposed on the security document that the authenticating mark is bringable over the verification element by bending or folding the security document.

42. The security document according to claim 39, characterized in that the security document exhibits a paper or plastic substrate.

43. The security document according to claim 39, characterized in that the authenticating feature is disposed in or over a window area or a through opening in the security document.

44. The security document according to claim 43, characterized in that the security document exhibits a plastic substrate and the authenticating mark is applied over a transparent or translucent, especially unprinted, area of the plastic substrate.

45. The security document according to claim 43, characterized in that the security document exhibits a paper substrate and the authenticating mark is applied over a through opening in the paper substrate.

46. The security document according to claim 43, characterized in that the security document exhibits a paper substrate and the authenticating mark is introduced into a through opening in the paper substrate with papermaking technology.

47. The security document according to claim 45, characterized in that the through opening is produced during paper manufacture without a sharp boundary edge of its border area.

48. The security document according to claim 39, characterized in that the security document is a security paper or a value document.

49. The security document according to claim 46, characterized in that the through opening is produced during paper manufacture without a sharp boundary edge of its border area.
